(19) United States
(12) Patent Application Publication
(10) Pub. No.: US 2015/0081509 A1
(43) Pub. Date: Mar. 19, 2015

(54) ONLINE MARKETPLACE FOR INVESTMENT IN DIAMONDS

(71) Applicant: Daryl Bank, Port St. Lucie, FL (US)

(72) Inventor: Daryl Bank, Port St. Lucie, FL (US)

(21) Appl. No.: 14/490,279

(22) Filed: Sep. 18, 2014

Related U.S. Application Data
(60) Provisional application No. 61/879,473, filed on Sep. 18, 2013.

(51) Int. Cl. G06Q 40/04; G06Q 30/00

(52) U.S. Cl. CPC G06Q 40/04; G06Q 30/018
USPC 705/37

(57) ABSTRACT

An online marketplace embodied in a computer system for facilitating investment in diamonds is disclosed. The online marketplace includes a database for storing customer records, wherein each customer record includes identifying information for a customer, contact information, an investment profile, and electronic payment information, and diamond records, wherein each diamond record includes identifying information for a diamond, characteristic information, certification information, and price information. The online marketplace further includes a server on a network and a processor configured for publishing the diamond records on a publicly available forum via the network, providing to customers a graphical user interface for allowing customers to search for and browse the diamond records, and executing a matching algorithm that determines which diamond records most closely match a customer, based on the information in the corresponding customer record, namely, the customer's investment profile.

### CROSS-REFERENCE TO RELATED APPLICATIONS

This patent application claims priority to provisional patent application No. 61/879,473 filed Sep. 18, 2013 and entitled “online Marketplace for Investment Diamonds.” Provisional patent application No. 61/879,473 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to an online marketplace for diamonds.

### BACKGROUND

With the advent of the Internet and the World Wide Web, the financial services industry as a whole has transitioned onto an e-commerce platform. This is well evidenced by the dwindling number of brick and mortar investment houses that require a customer to be physically present to engage in an investment. With the transition of the financial services industry onto an e-commerce platform, there has been a dramatic effect in the way financial services are rendered, giving rise to a new set of e-commerce sites that are designed especially to cater to investors seeking to purchase investments on their own, i.e., without the use of a broker or intermediary. For example, online financial service sites such as GoldLine.com and BlanchardOnline.com offer e-commerce sites that sell gold directly to investors. Gold and other tangible precious commodities have enjoyed increasing popularity recently, since investors often revert to tangible commodities when the economy is down.

Such tangible precious commodities, however, have their drawbacks. Gold and silver, for example are very heavy, in proportion to their volume. A standard gold bar (measuring approximately 6 inches by 3 inches by 2 inches), for example, weighs more than 27 pounds or 400 ounces. At gold's current price of about $1300 per ounce, a standard gold bar represents about $500,000 in value. Thus, an investor desiring to convert a modest $1 million into gold, would require over 50 pounds of gold. A $2 million investment would require over 100 pounds of gold. Consequently, the heavy weight of gold and other precious metals eliminate the use of gold as an easily carried or easily stored commodity.

Another drawback to tangible precious commodities is the inability of lay investors to evaluate the commodity being purchased and verify its authenticity. Gold, for example, comes in many different forms, such as 10 karat, 14 karat and 18 karat, and in many different shapes, such as bars, bullion, and coins. Most lay investors do not have the ability to test the authenticity of the precious commodity being purchased. This lack of information and lack of confidence prevents many investors from entering into the market for tangible precious commodities.

Therefore, a dire need exists for improvements over the prior art, and more particularly, a consolidated method and system for facilitating the purchase of certified or authenticated investments in easily-transported tangible, precious commodities via an e-commerce medium.

### SUMMARY

According to the aspects illustrated herein, an online marketplace embodied in a computer system for facilitating investment in diamonds is disclosed. The online marketplace includes a database for storing a plurality of customer records, wherein each customer record includes identifying information for a customer, contact information for the customer, an investment profile for the customer, and electronic payment information for the customer, and a plurality of diamond records, wherein each diamond record includes identifying information for a diamond, characteristic information for the diamond, certification information for the diamond, and price information for the diamond. The online marketplace further includes a server comprising a network interface device communicatively coupled to a communications network and a processor configured for publishing the plurality of diamond records on a publicly available forum via the communications network, providing to customers a graphical user interface via the communications network for allowing customers to search for and browse the diamond records, and executing a matching algorithm that determines which diamond records most closely match a customer, based on the information in the corresponding customer record, namely, the customer's investment profile, and displaying for the customer said diamond records that most closely match the customer.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

### BRIEF DESCRIPTION OF THE DRAWINGS

The accompanying drawings, which are incorporated in and constitute a part of this disclosure, illustrate various example embodiments. In the drawings:

FIG. 1 is a block diagram illustrating a network architecture of an online marketplace embodied in a computer system for facilitating investment in diamonds over a communications network, in accordance with one embodiment.

FIG. 2 is a flow chart illustrating the control flow for an online marketplace embodied in a computer system for facilitating investment in diamonds over a communications network, in accordance with one embodiment.

FIG. 3 is a block diagram illustrating the data flow for an online marketplace embodied in a computer system for facilitating investment in diamonds over a communications network, in accordance with one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The disclosed embodiments overcome shortcomings of the prior art by providing investors with an e-commerce platform that allows investors to purchase certified diamonds that match their investment profile. The disclosed embodiments further overcome the drawbacks of the prior art by providing investors with a precious commodity that is easy to transport, store and carry. At a price of $50 to $10,000 a carat (depending on the size of the diamond, as well as its color, clarity, etc.), a pound of diamonds can represent anywhere from about $100,000 to about $22 million in value—making diamonds a tangible, precious commodity that is very easy to transport, carry in person and store. Additionally, the disclosed embodiments are further advantageous because they ensure that each diamond is verified or authenticated by a certifying body, thereby providing investors with the information and confidence required when making large investments.

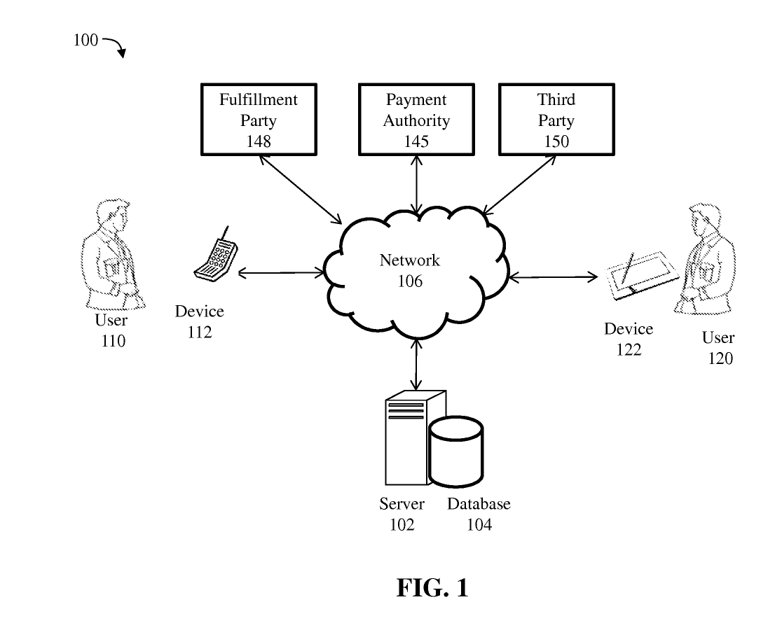

Referring now to the drawing figures in which like reference designators refer to like elements, there is shown in FIG. 1 an illustration of a block diagram 100 showing the network architecture of an online marketplace embodied in a computer system for facilitating investment in diamonds over a communications network.

A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, an online marketplace for facilitating investment in diamonds over a communications network 106.

FIG. 1 includes stationary or mobile computing devices 112 and 122, which may be desktop computers, workstations, smart phones, mobile phones, tablet computers, handheld computers, laptops, or the like. Computing devices 112 and 122 correspond to users 110 and 120, who may be any user of a computing device.

FIG. 1 further shows that server 102 includes a database or repository 104, which may be a relational database comprising a Structured Query Language (SQL) database stored in a SQL server. Devices 112, 122 may also each include their own database. The repository 104 serves data from a database, which is a repository for data used by server 102 and devices 112, 122 during the course of operation of the disclosed embodiments. Database 104 may be distributed over one or more nodes or locations that are connected via network 106.

The database 104 may include a user record for each user 110 or 120. A user record may include: contact/identifying information for the user (name, address, telephone number(s), email address, date of birth, social security number, a photo, etc.), a user address identifier (such as an email address, text message address, UseNet address, mobile phone number, etc), etc. A user record may also include a unique identifier for each user, a residential address for each user, the current location of each user (based on location-based services from the user's mobile computer) and demographic data for each user, such as age, sex, income data, race, color, marital status, etc.

A user record may also include a user name, a user account password, personal information, professional information, an investment profile for the customer (amount of investment, frequency, risk profile, time of investment, etc.), and electronic payment information for the customer (purchase card information, credit card information, bank account information, etc.).

The database 104 may further include a diamond record for each diamond system 100 manages, which may include identifying information for a diamond (unique identifier, name, SKU, code, etc.), characteristic information for the diamond (cut, clarity, carat size, color, etc.), certification information for the diamond, and price information for the diamond (in U.S. dollars, for example). Certification information for the diamond refers to any independently produced report or certification data attesting to the authenticity of a diamond and its characteristics. Certification information may include a unique identifier that corresponds to a certification report or a certificate.

All diamonds in the marketplace of the disclosed embodiments conform to specified physical/gemological standards and optical standards, such as the applicable physical/gemological standards of the Gemological Institute of America (GIA). Each diamond is associated with a certification or report, such as a Diamond Grading Report or Diamond Dossier from the Gemological Institute of America. All diamonds in the marketplace shall have the certification or report number laser inscribed on their girdle, along with an applicable trademark and an identification serial number for authentication purposes. Further, diamonds may be pre-packaged in a tamper proof package, such as a shrunk wrap plastic packaging material or a sealed enclosure with tamper proof capabilities. The tamper proof package may include the date of verification, a unique identifier, a description of the diamond, and certifying trademarks or indicia. In one embodiment, all diamonds in the marketplace shall be natural, non-enhanced diamonds. In addition, all diamonds shall be certified to be other than a “conflict” diamond and purchased only from regulated sources. Diamond records and customer records may be linked or contain references to other records.

Certification information for a diamond may include a certification or report, such as a Diamond Grading Report or Diamond Dossier from the Gemological Institute of America. Certification information for a diamond may also include a high resolution photograph of said selected diamond showing the certification or report number laser inscribed on the girdle, along with an applicable trademark and an identification serial number for authentication purposes. Certification information for a diamond may also include a high resolution photograph of said tamper proof package, which may include the date of verification, a unique identifier, a description of the diamond, and certifying trademarks or indicia.

FIG. 1 shows an embodiment of the present invention wherein networked computing devices 112, 122 interact with server 102 and repository 104 over the network 106 in the course of engaging in diamond trading or investing activities. Server 102 includes a software engine that delivers applications, data, program code and other information to networked computing devices 112, 122. It should be noted that although FIG. 1 shows only the networked computers 102, 112, 122, the system of the disclosed embodiments supports any number of networked computing devices connected via network 106. Further, server 102 and devices 112, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 112, 122. Further, server 102 and its functionality, according to a preferred embodiment, can be realized in a centralized fashion in one computer system or in a distributed fashion wherein different elements are spread across several interconnected computer systems.

The system 100 for the online marketplace for diamonds may be used when a user or multiple customers, engage with the server 102 to log into the marketplace as a first time user or as an existing user. Said user, such as user 110, first connects a computing device 112 to server 102 via the network 106. First time users or customers may create a new account, including entering user information such as username, password, re-entering password and populating other applicable user information to be stored in the user account database 104. Existing users, who have already created a user account, may access the user account by re-entering user information such as username, password and/or other applicable user information. The server 102 will retrieve stored information from the user account database 104 for the existing user. Wherein the user has an existing account, the user may simply log in to the existing account. With a registered account, a first time user becomes a member of the online marketplace of the disclosed embodiments.

FIG. 1 also shows a payment authority 145, which acts to effectuate payments by users for investment diamonds, products, services or the like. In the course of a sales or investment transaction, server 102 may interface with payment authority 145 to effectuate payment. In one embodiment, the payment authority 145 is a payment gateway, which is an e-commerce Application Service Provider (ASP) service that authorizes and processes payments from one party to another. The payment authority 145 may accept payment via the use of wire transfer, bank transfer, or purchase cards, i.e., credit cards, charge cards, bank cards, gift cards, account cards, etc. Note that although party 145 is shown as a single and independent entity, in one embodiment of the present invention, the functions of party 145 may be integrated with another entity, such as server 102. Further, the functionality of party 145 may be realized in a centralized fashion in one computer system or in a distributed fashion wherein different elements are spread across several interconnected computer systems.

FIG. 1 further shows fulfillment party 148, which performs product fulfillment or order fulfillment services, i.e., the process of fulfilling the obligation of server 102 (or the entity represented by server 102) to send a customer or user one or more diamonds or precious stones that the customer has ordered, purchased, or requested from the server 102 (or the entity represented by server 102). Fulfillment party 148 may store products, receive orders for the products, package the products, and then ship the ordered products to the end customer. In the course of a sales or investment transaction, the server 102 may interface with fulfillment party 148 to effectuate the delivery of purchased products to the customers after payment has been effectuated via the payment authority 145. Note that although party 148 is shown as a single and independent entity, in one embodiment of the present invention, the functions of party 148 may be integrated with another entity, such as server 102. Further, the functionality of party 148 may be realized in a centralized fashion in one computer system or in a distributed fashion wherein different elements are spread across several interconnected computer systems.

FIG. 1 further shows optional third party 150, which may be the owner, holder, possessor and/or the clearinghouse for the diamonds or precious stones that the customer has ordered, purchased, or requested from the server 102 (or the entity represented by server 102). Third party 150 may store diamonds or precious stones that are fulfilled by itself or by party 148. In the course of a sales or investment transaction, the server 102 may interface with third party 150 to effectuate the supply of purchased diamonds or precious stones to the customers or fulfillment party 148 after payment has been effectuated via the payment authority 145. Note that although party 150 is shown as a single and independent entity, in one embodiment of the present invention, the functions of party 150 may be integrated with another entity, such as server 102 or party 148. Further, the functionality of party 150 may be realized in a centralized fashion in one computer system or in a distributed fashion wherein different elements are spread across several interconnected computer systems.

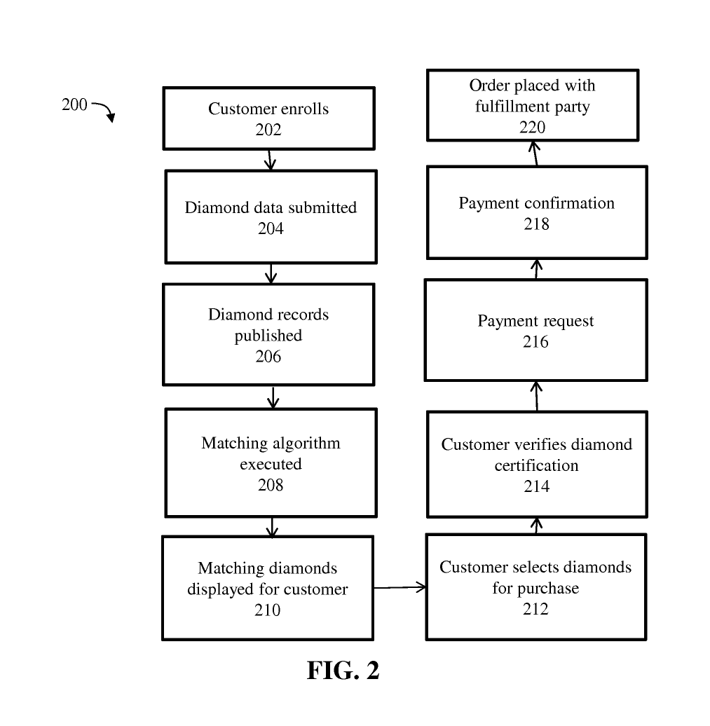

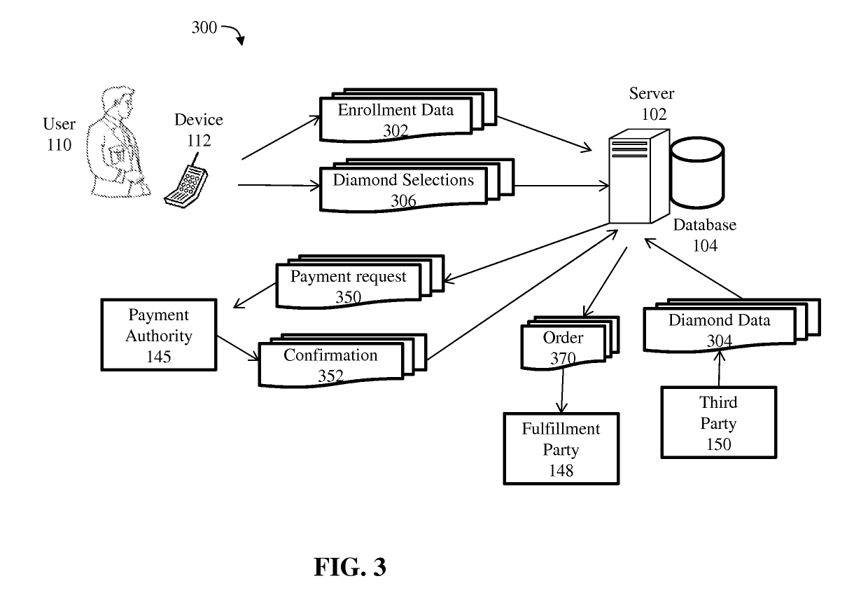

The process for facilitating investment in diamonds over a communications network over a communications network 106 will now be described with reference to FIGS. 2 through 3 below, which provide diagrams 200 and 300 illustrating the control flow and data flow, respectively, for a system for facilitating investment in diamonds over a communications network, in accordance with one embodiment.

In a first step 202, a user 110 may enter various data sets into database 104 for processing and management by server 102. User 110 may enter enrollment data 302 (i.e., any of data defined above for a customer record) into database 104 via network 106. User 110 may enter enrollment data 302 into his device 112 by manually entering data into a client or mobile application via keypad, touchpad, or via voice. User 110 may enter purchase card data, or a portion thereof, into his device 112 by swiping the purchase card through a card reader communicatively coupled with the device 112. A card reader is a data input device that reads data from a card-shaped storage medium. One example of a card reader is a magnetic card reader, which reads magnetic stripe cards, such as credit cards. A mobile card reader is a card reader that is communicatively coupled with a mobile computing device. User 110 may alternatively enter purchase card data into his device 112 by using RFID or NFC. In one embodiment, upon reading any purchase card data from purchase card, the device 112 immediately encrypts the purchase card data that was read, so as to produce encrypted purchase card data. In this embodiment, the encrypted purchase card data from the purchase card is transmitted to the server 102 in enrollment data 302.

In one embodiment, server 102 may provide to customers a graphical user interface via the communications network 102 that elicits investment profile data from customers using a questionnaire. Said investment profile data is then uploaded to the server 102 via network 106 as part of enrollment data 302.

Once enrollment data 302 has been entered, server 102 creates one or more unique customer records in database 104 that hold said enrollment data. In step 204, third party 150 may enter diamond data 304 (i.e., any of data defined above for a diamond record) into database 104 via network 106. Once diamond data 304 has been entered, server 102 creates one or more unique diamond records in database 104 that hold said diamond data.

In step 206, the server 102 publishes the plurality of diamond records on a publicly available forum (such as a web site) via the communications network 106. Said web site provides customers a graphical user interface via the communications network 106 for allowing customers 110, 120 to browse the diamond records. Said web site also provides customers a graphical user interface via the communications network 106 for allowing customers to search for and browse the diamond records according to user-specified search parameters.

In step 208, the server 102 executes a matching algorithm that determines which diamond records most closely match a customer, based on the information in the corresponding customer record, namely, the customer's investment profile. Specifically, in step 308, the server 102 reads the investment profile from a customer record in database 104, including characteristic information for one or more diamonds, price information and a number of diamonds. The investment profile may also include an amount of investment, a buying/investment frequency, risk profile or risk status of the customer, and a time of investment. Next, server 102 accesses the plurality of diamond records in database 104 and compares some or all of the investment profile data from the customer record to the data in each diamond record. Finally, server 102 identifies one or more diamond records including data that match, within a predefined matching parameter, the investment profile data from the customer record.

In step 210, the server 102 displays for the customer said diamond records (or some of the information in said records) that most closely match the customer. In step 212, the server 102 provides to the customer a graphical user interface via the communications network 106 for allowing the customer to select (in data 306) one or more displayed diamonds and purchase customer-selected diamonds using the electronic payment information stored in the customer's record. Said data 306 is transmitted to server 102 from user 110's device 112. A graphical user interface may comprise an interface displayed in a web browser.

In optional step 214, the server 102 provides to the customer a graphical user interface via the communications network 106 for allowing the customer to verify the certification information in the diamond record of a particular diamond. Said graphical user interface may display for each selected diamond the associated certification or report, such as a Diamond Grading Report or Diamond Dossier from the Gemological Institute of America. Said graphical user interface may also display for each selected diamond a high resolution photograph of said selected diamond showing the certification or report number laser inscribed on the girdle, along with an applicable trademark and an identification serial number for authentication purposes. Said graphical user interface may also display for each selected diamond a high resolution photograph of said tamper proof package, which may include the date of verification, a unique identifier, a description of the diamond, and certifying trademarks or indicia.

In step 216, the server 102 sends a request for payment 350 to payment authority 145. The request for payment 350 may include the monetary amount that corresponds to the diamonds that will be delivered to the customer 110 and electronic payment information from his customer record, or data garnered from his purchase card. Payment authority 145 then processes said payment using said payment information. If said payment is processed an cleared, then in step 218, the payment authority 145 sends a confirmation of payment 352 back to server 102.

In step 220, the server 102 sends an order 370 to fulfillment party 148. The order 370 may include a description or unique identifiers (such as SKUs) for the diamonds that will be delivered to the customer 110 (as selected by the user in data 306) and the contact information for the customer 110 from his customer record. In step 322, the fulfillment party 148 fulfills the order 370 by shipping or delivering the specified diamonds to the customer 110. In the course of shipping or delivering the specified diamonds to the customer 110, said fulfillment party 150 may pre-package the diamonds in a tamper proof package, such as a shrunk wrap plastic packaging material or a sealed enclosure with tamper proof capabilities. The tamper proof package may include the date of verification, a unique identifier, a description of the diamond, and certifying trademarks or indicia.

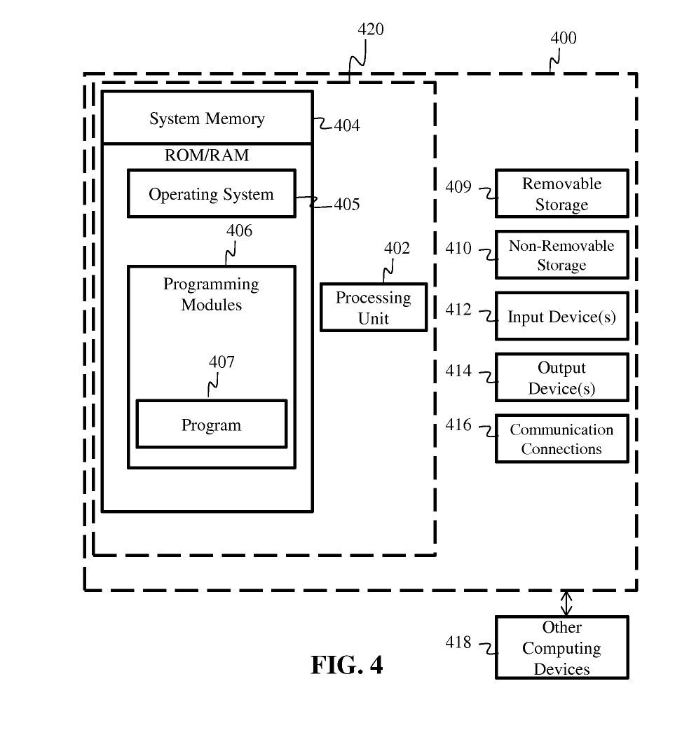

FIG. 4 is a block diagram of a system including an example computing device and other computing devices. FIG. 4 is a block diagram of a system including an example computing device 400 and other computing devices. Consistent with the embodiments described herein, the aforementioned actions performed by 102, 112, 122 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An online marketplace embodied in a computer system for facilitating investment in diamonds, comprising:
a database for storing:
a plurality of customer records, wherein each customer record includes identifying information for a customer, contact information for the customer, an investment profile for the customer, and electronic payment information for the customer; and
a plurality of diamond records, wherein each diamond record includes identifying information for a diamond, characteristic information for the diamond, certification information for the diamond, and price information for the diamond; and
a server comprising a network interface device communicatively coupled to a communications network and a processor configured for:
publishing the plurality of diamond records on a publicly available forum via the communications network;
providing to customers a graphical user interface via the communications network for allowing customers to search for and browse the diamond records; and
executing a matching algorithm that determines which diamond records most closely match a customer, based on the information in the corresponding customer record, namely, the customer's investment profile, and displaying for the customer said diamond records that most closely match the customer.

2. The online marketplace of claim 1, wherein the processor is further configured for:
providing to customers a graphical user interface via the communications network that elicits investment profile data from customers using a questionnaire.

3. The online marketplace of claim 2, wherein the processor is further configured for:
providing to customers a graphical user interface via the communications network for allowing customers to purchase customer-selected diamonds using the electronic payment information stored in the customer's record.

4. The online marketplace of claim 3, wherein the processor is further configured for:
providing to customers a graphical user interface via the communications network for allowing customers to verify the certification information in the diamond record of a particular diamond.

5. The online marketplace of claim 4, wherein the matching algorithm comprises the steps of:
reading the investment profile from a customer record, including characteristic information for one or more diamonds, price information and a number of diamonds;
accessing the plurality of diamond records and comparing the investment profile data from the customer record to the data in each diamond record; and
identifying one or more diamond records including data that match, within a predefined matching parameter, the investment profile data from the customer record.

6. The online marketplace of claim 5, wherein the communications network comprises the Internet.

7. The online marketplace of claim 6, wherein a graphical user interface comprises an interface displayed in a web browser.

8. An online marketplace embodied in a computer system for facilitating investment in diamonds, comprising:
a database for storing:
a plurality of customer records, wherein each customer record includes identifying information for a customer, contact information for the customer, investment profile data for the customer, and electronic payment information for the customer; and
a plurality of diamond records, wherein each diamond record includes identifying information for a diamond, characteristic information for the diamond, certification information for the diamond, and price information for the diamond; and
a server comprising a network interface device communicatively coupled to a communications network and a processor configured for:
publishing the plurality of diamond records on a publicly available forum via the communications network;
providing to a customer a graphical user interface via the communications network for allowing said customer to search for and browse the diamond records;
executing a matching algorithm that determines which diamond records most closely match said customer, based on the information in a corresponding customer record, namely, said customer's investment profile data, wherein the matching algorithm comprises reading investment profile data from said customer record, including characteristic information for one or more diamonds, price information and a number of diamonds, accessing the plurality of diamond records and comparing the investment profile data from said customer record to data in each diamond record, and identifying one or more diamond records including data that match, within a predefined matching parameter, the investment profile data from said customer record;
displaying for said customer said diamond records that most closely match said customer; and
providing to said customer a graphical user interface via the communications network for allowing said customer to purchase customer-selected diamonds from said diamond records that most closely match said customer, using the electronic payment information stored in said customer's record.

9. The online marketplace of claim 8, wherein the investment profile data may also include an amount of investment, a buying/investment frequency, a risk profile or risk status of said customer, and a preferred time of investment.

10. The online marketplace of claim 3, wherein the processor is further configured for:
providing to said customer a graphical user interface via the communications network for allowing said customer to verify the certification information in the diamond record of a particular diamond.

11. The online marketplace of claim 10, wherein said graphical user interface may display for a particular diamond an associated certification data.

12. The online marketplace of claim 11, wherein said graphical user interface may display for a particular diamond a high resolution photograph of said diamond showing a certification number laser inscribed on said diamond's girdle.

13. The online marketplace of claim 12, wherein said graphical user interface may display for a particular diamond a high resolution photograph of a tamper proof package containing said diamond.

14. The online marketplace of claim 13, wherein the communications network comprises the Internet.

15. The online marketplace of claim 14, wherein a graphical user interface comprises an interface displayed in a web browser.
